(19) United States
(12) Patent Application Publication
(10) Pub. No.: US 2014/0317644 A1
(43) Pub. Date: Oct. 23, 2014

(54) MONETIZING PRODUCT PLACEMENT, CONSUMER, AND VENDOR DATA

(71) Applicant: Ana Bermudez, San Diego, CA (US)

(72) Inventor: Ana Bermudez, San Diego, CA (US)

(21) Appl. No.: 14/255,830

(22) Filed: Apr. 17, 2014

Related U.S. Application Data
(60) Provisional application No. 61/812,803, filed on Apr. 17, 2013.

(51) Int. Cl. H04N 21/2547; H04N 21/435; H04N 21/81; H04N 21/442

(52) U.S. Cl. CPC H04N 21/2547; H04N 21/44222; H04N 21/435; H04N 21/812
USPC 725/9

(57) ABSTRACT

A method and a non-transitory machine-readable medium are used to monetize product placements integral with video programs. A promotion company obtains information identifying products placed in a program and provides it to a viewer on a second screen having a graphical user interface. The promotion company provides for interactions such as associating a product with a preferred vendor or providing for communications between users. Data is tracked and collected data is categorized and processed to produce salable information.

### CROSS-REFERENCE TO RELATED APPLICATIONS

This application claims priority from provisional application Ser. No. 61/812,803, entitled “Monetizing Product Placement, Consumer, and Vendor Data,” filed on Apr. 17, 2013. The contents of this provisional application are fully incorporated herein by reference.

### BACKGROUND OF THE INVENTION

1. Field of the Invention

The present subject matter relates to monetizing product placement data, consumer data, and vendor data.

2. Related Art

A product placement is the display of a product in a program, such as a broadcast or recorded television program, as though it were an integral part of the program but acts as advertising for the placed product. Product placement has gained importance since the advent of digital video recording. Video recording allows viewers to fast-forward through commercials and past commercials in order to see only the program and not the commercials. Since the product placement is integral with the program, it cannot be skipped without skipping at least a portion of the program.

Given that product placement is a growing phenomenon, various prior art techniques have been developed in order to make the product placement advertising useful to viewers.

United States Published Patent Application No. 2013/0061262 discloses a method for presenting advertisements for commercial products in video productions. The commercial product is placed in a video program as an element of the video production. A viewer is enabled to interact with the video production to select the product. Information is then displayed about the selected product. Products are indexed by pre-defined “cue points” corresponding to times in the program when the product appears. When a viewer initiates a trigger signal corresponding to the queue point, advertisement is transmitted from a server for display in the video player. The advertisement corresponding to the queue point includes a selection enabled portion that allows a viewer of the video player to interactively retrieve further information about a product or service.

The viewer must trigger a cue point and cannot select to view by product. The advertisement that is displayed is an overlay on the video program and disappears after a predetermined time. Very little flexibility is provided in permitting a viewer to utilize information at the viewer's own option. There is no selectable range of user interactions.

U.S. Pat. No. 7,899,705 discloses a system wherein a visual image on a film or television program is utilized to market a specific product. The technique, requires the program to be digitally recorded, and pixel data must be recorded for each product for which marketing data will be available. Objects may be extracted from an existing television show using known shapes of objects. This sort of analysis requires significant computing capacity. This technique relies on coding to distinguish one product from another. Encoding is complicated. It cannot be implemented simply in a viewer's portable device with limited RAM capacity for real-time response.

U.S. Pat. No. 8,244,597 discloses a system in which a first user, called an endorsing user, browses the content sources and selects a content item, entering a code associated with the selected content element to view product information. Another viewer, called a viewing user, who also subscribes to the content source, may see information about the same product. A viewing user may also view the product information selected by the first viewer. This system provides information. However, it does not relate to product placement.

United States Published Patent Application No. 2013/0019261 discloses a method that comprises displaying a video program having an interactive advertisement to a user on a display screen. The interactive advertisement includes an enhanced content activator. A user can activate an enhanced content activator, and enhanced advertisement information will be accessed and will provide a trigger signal, which causes advertisement information to be displayed with the video program and the interactive advertisement. This system requires the production of enhanced content, which significantly increases the complexity of producing programming. The range of interactions that can be selected by a user is limited.

In United States Published Patent Application No. 2012/0158514, content for purchasing and viewing by users is provided. The system identifies a user device used by the user for viewing the selected content. Additional content for the selected user is provided based on the identified user device. A user may have additional content provided. This disclosure does not show advertising placement.

U.S. Pat. No. 8,364,524 shows a computer system that includes a communication device configured to exchange communications with a user in order to enable the user to interact in a participation television segment. The computer system also includes a participant identification device configured to automatically identify the participant based on information received from the participant electronic device. Users are given a premium as an incentive to interact with the system. This disclosure relates to interaction with advertising content but does not relate to product placement.

United States Published Patent Application No. 2012/0096486 discloses a system and method for interactive video advertising comprising advertising overlays that are displayed on a video screen to prompt user interaction. User interaction causes additional advertising content to be made available in a user interface that may be accessed immediately or at a later point in time. There is interaction with a pre-recorded program. However, this method relates to selection of advertising content provided to a user interface without regard to product placement.

### SUMMARY

Briefly stated, in accordance with the present subject matter, a method and a non-transitory machine-readable medium are provided for monetizing product placements integral with video programs and using generated information to enable creation of further types of information that can be monetized.

An entity, referred to as a promotion company in the present specification performs services utilizing the present method and non-transitory machine-readable medium. Information obtained by the promotion company identifies products placed in a program. The information may be obtained from a program producer or other appropriate source. The program is then a “contracted program.” This term does not imply any particular requirements on the program or its use. The term is used to identify a program for which the product placement information has been obtained.

The promotion company may monetize its information in several ways. A product is associated with a preselected retail source selected by the promotion company. When a user elects to buy a placed product, the preferred vendor is the default source for order fulfillment.

The promotion company may link a particular local retailer in the user's geographical area with a particular product. Users may be grouped by demographic or other category in the alternative to geographical location. The preselected retail source is also referred to as a preferred vendor. The promotion company monetizes its ability to confer preferred vendor status.

Other connections that may be monetized include providing alternatives to the preferred local vendor, e.g., Amazon.com. The promotion company will earn a commission on sales channeled to the preferred vendor. Additionally, collected data may be categorized and mined to produce salable information. The promotion company provides an app to users. The app allows for many forms of interaction and provides a graphical user interface (GUI) for the user to interact with the displayed information. The graphical user interface may identify whether a currently viewed program is a contracted program. The selected program may be chosen in accordance with a user profile, stored television program schedule, or in response to a user query. Profiles may be created upon which many functions can be based. Upon selection of a user to utilize the functions, lists in a graphical user interface are populated with product information relating to placed products. The viewer is provided with options to obtain information, save information, communicate with other users via a social network, and to buy the product.

### BRIEF DESCRIPTION OF THE DRAWINGS

The present subject matter may be further understood by reference to the following description taken in connection with the following drawings:

FIG. 1 consists of FIGS. 1A and 1B, wherein FIG. 1A is a block diagram of a portion of a system in which a present method for monetizing the use of product placement information in television programs is practiced, and FIG. 1B is a block diagram of a portion of the system in which method steps including the use of product placement information are performed;

FIG. 2 is a block diagram illustrating mechanisms for monetizing product placement data;

FIGS. 3-8 are illustrations of a graphical user interface operating in a variety of user-selected modes;

FIGS. 9-12 illustrate user interactions with displayed data;

FIG. 13 is an illustration of data gathering in one preferred embodiment;

FIG. 14 illustrates an example of conversion of collected data into a specific result;

FIG. 15 illustrates a data mining process;

FIG. 16 illustrates various data-handling algorithms that may interact in the performance of the present method; and

FIG. 17 is a flowchart illustrating a method and non-transitory machine-readable medium for user interaction in accordance with the present subject matter.

### DETAILED DESCRIPTION

A promotion company can make a deal with producers of contracted programs for payment for making product placement information available in an actionable form to users. The promotion company may also make deals with selected retailers to steer customers ready to purchase to retailers in a viewer's geographical area or to steer the customer to an online marketplace at the viewer's option. The promotion company can earn commissions from the sellers. The promotion company also collects data on purchases, “likes,” recommendations from one viewer to another, preferred purchasers, and additional information registered from interactions of viewers with the system. This information is collected, ordered, and mined to produce data in salable form for retailers, marketers, and others who utilize market information.

The designations of a promotion company and program company are used for convenience in this description. It is not necessary that a particular form of company perform the described actions or that the actions be distributed over two companies.

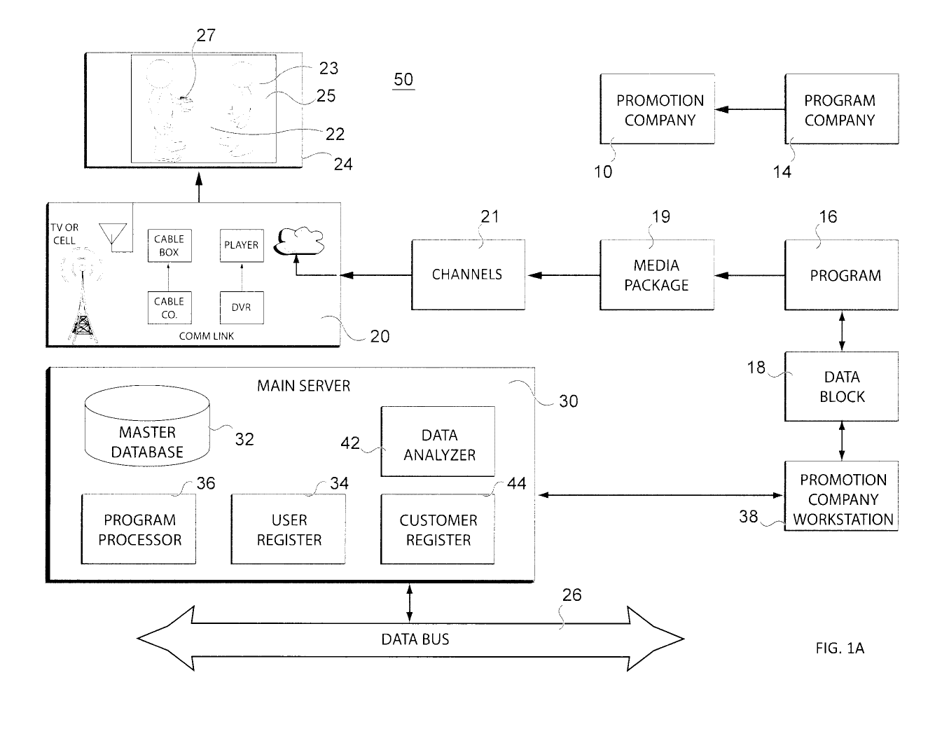

FIGS. 1A and 1B illustrate a system in which a present method for monetizing the use of product placement information in television programs is practiced. FIG. 1A illustrates a source section 50 of the system in which the source information for further utilization by viewers is included. FIG. 1B illustrates a user section 60 in which client devices using source information and external information are included. The source section 50 communicates to the user section 60 via a data bus 26.

FIG. 1A illustrates a viewing screen 25 displaying a picture 23 with a scene from a program 22 including a placed product 27. In a preferred form, the system is operated by a promotion company 10. The promotion company 10 obtains product placement information from a program company 14. The program 22 is the program as produced by the program company 14. The program 22 will be seen by all viewers whether or not they are using the present system. The components in FIG. 1A are discussed as discrete entities. This is only for explanation, and is not limiting. The functions described below may be distributed in any number of arrangements through a number of components or may be embodied in other discrete components.

The program company 14 produces at least one program 16. The program company 14 makes deals with advertisers to place products in the program 16. The information relating to products in the show may be visualized as a data block 18. The promotion company 10 may make a contract with the program company 14 for rights to obtain and use the data block 18. A program 16 for which such an arrangement has been made is referred to as a “contracted program 16.” This term is used for convenience in description and is in no way limiting. The program company 14 has lists of product placements in each show which comprise data in the data block 18. The promotion company 10 seeks to make an arrangement with the program company 14 so that the promotion company 10 can transform the data block 18 to produce new and useful information in forms which may vary and which may be of use to the program company 14, retailers, wholesalers, online markets, advertisers and viewers. A company, usually the program company 14, assembles a media package 19. The media package 19 is sent to channels 21 for transmission via a communications link 20.

The program 16 is coupled to an entertainment device 24 by the communications link 20. The entertainment device 24 may take many forms. The entertainment device 24 includes a viewing screen 25. In various embodiments, the entertainment device 24 may comprise a smart television, smartphone, tablet computer, or other devices not yet in existence but which are sure to appear in the future. The communications link 20 may comprise a television broadcast, satellite or cable system, cell phone network or Wi-Fi hotspot. Also, recorded media may be played to provide an input to the entertainment device 24. The communications link 20 may be viewed as recorded media which is loaded with a program and a player which plays the media.

The promotion company 10 maintains a main server 30 housing a master database 32. A user register 34 contains data for tailoring data to be displayed to the user 6 (FIG. 1B). A program processor 36 accesses data, routinely processes some data, and transforms other data into a form usable for new purposes. The program processor 36 may coordinate communication with entities outside the master database 32 via a data bus 26. The promotion company 10 may maintain a promotion company workstation 38 coupled to receive information and to provide information in a form selected by the promotion company 10 to the main server 30. The master database 32 may also be loaded with schedules for programs for respective users' locations and identity of contracted programs.

The main server 30 may further include a data analyzer 42 and a customer register 44. These elements do not need to comprise discrete circuits. They are illustrated as such for ease in description. Virtually all data collected in the user section 60 (FIG. 1B), may be transmitted to the main server 30 in order to be analyzed, transformed, and processed by the data analyzer 42 to provide data products further described below. The customer register 44 may store identities of viewers, identities of product providers, and identities of program companies 14 for the purpose of delivering data products that have been subscribed to.

In the current illustration, the program company 14 transmits the data block 18 to the promotion company workstation 38. The promotion company workstation 38 transmits data to the master database 32 more specifically described below. For convenience in description only, the systems and modules on the promotion company 10 side of the main server 30 are referred to as the source section 50. Exact location of the components of the source section 50 is not critical. Locations may be varied within the requirements of the structure and operation further described below. The source section 50 interacts with the user section 60, illustrated in FIG. 1B via the data bus 26.

In FIG. 1B, the data bus 26 may communicate with a product information database 72, a product selection register 78, user interface device 84, user device display 88, collection database 94, network interface 98, and a data collection interface 100. The user interface device 84 may be operated by user controls 86. The user interface device 84 may be included in a hand-held remote control unit. An app 80 may be installed on the user interface device 84 to coordinate communications and operations. The app 80 is further described with respect to Table I, which follows this description.

A user 6 watches the program 22 on a screen 123. The program 22 is the same program that is seen on the screen 25 (FIG. 1A). The user interface device 84 may include an indicator 110 which could comprise, for example, an LED. The user interface device 84 receives information from the main server 30 (FIG. 1A) indicative of a television schedule and the identity of contracted program 16. The indicator 110 is activated in response to a contracted program 16 either being displayed or occurring at the same time as a current program displayed on the screen 123. The user 6 may operate the user interface device 84 to select a channel 21 (FIG. 1A) showing a contracted program 16. The user 6 may select a “list products” command via the user interface device 84 to cause a graphical user interface (GUI) 120 to appear on a portion of the screen 123 to display a placed products list 122. If the entertainment device 24 is not a smart TV, the user may view the placed products list 122 on a user device display 88. The user device display 88 may be the screen of a smartphone.

With the user interface device 84, the user 6 may select a product for which further information will be provided. The information will be provided on a placed products section 124. Various options will be available as further described below.

The app 80 will ask the user 6 if the user 6 wants to watch the contracted program 16. If user 6 elects this option, the GUI 120 appears.

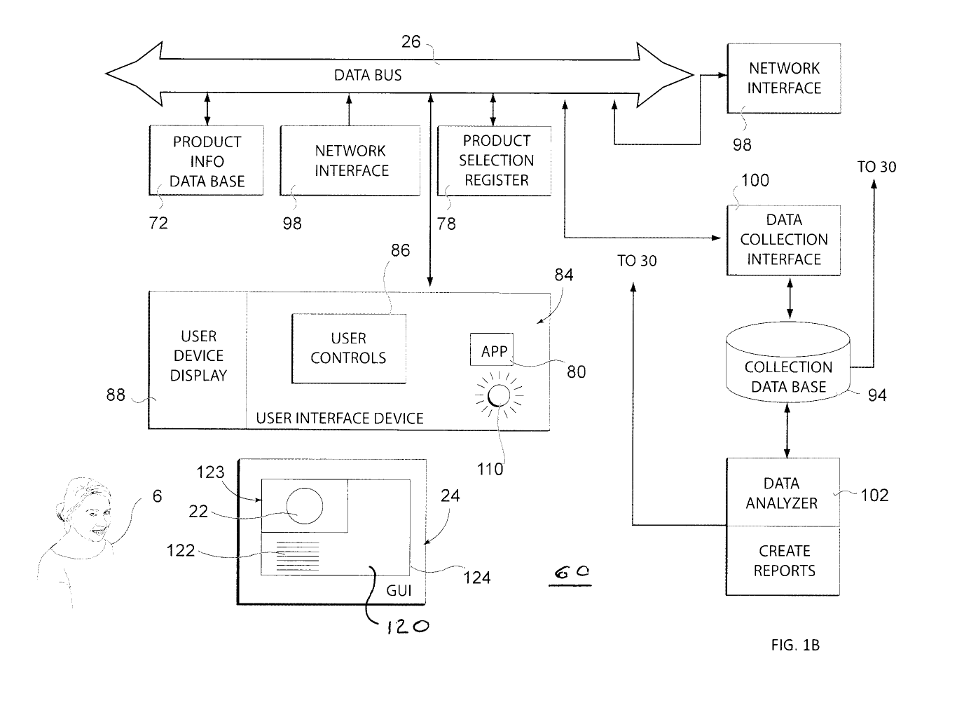

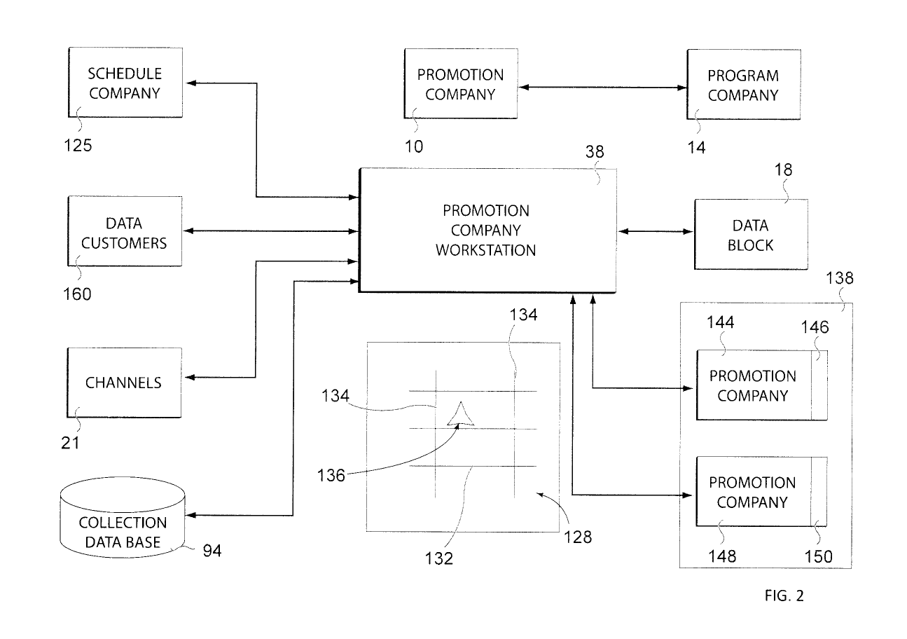

FIG. 2 is a block diagram illustrating mechanisms for monetizing product placement data. The promotion company workstation 38 is illustrated as a central communication point. Other central locations, e.g., the main server 30 (FIG. 1A), could be provided. The promotion company 10 communicates with the program company 14 in order to obtain data blocks 18. The promotion company 10 obtains program data from a schedule company 125 which produces television listings. The program company 14 packages data for use. The promotion company 10 combines the television listing data with its list of contracted programs to produce an annotated schedule 128 with listings 132, along time line markers 134. The promotion company 10 inserts a flag 136 for each contracted program 16. The flag 136 is used to signal the user interface device 84 (FIG. 1B) to activate the indicator 110, thus alerting the user 6 that a contracted program 16 is available.

The program company 14 transmits data blocks 18 to the promotion company workstation 38. The program company 14, which may be an advertising agency, pays a negotiated fee to the promotion company 10 for each contracted program 16. The promotion company 10 provides data to channels 21 for transmission, e.g., by broadcasting, to a plurality of users 6.

The promotion company 10 maintains a vendor database 138. The promotion company 10 selects criteria for selection of a prime vendor for each of a plurality of particular segments of the user 6 population. Segments could be geographical, such as a city or Standard Metropolitan Statistical Area. Segments could be non-geographical, for example, domain names with an .edu suffix. The promotion company 10 negotiates with prime vendor candidates in a prime vendor database 144 and selects a prime member candidate 146 who will pay an agreed upon amount for the advantage of being in the first buy box when a user 6 makes a buy selection. Additionally, the promotion company 10 negotiates with alternate vendor candidates 150 listed in an alternate vendor database 148. Preferred alternate vendor candidates will generally be online marketplaces, for example, Amazon.com. As further discussed below, sales by each vendor are monitored, and the promotion company 10 is paid a commission.

The promotion company 10 also communicates with the collection database 94. This database captures the identity of users 6, items reviewed, sales, prime or alternate vendor selections, communications with social databases, “likes,” total dollars spent, time spent per selected tasks such as total time online or total time per vendor, and other data. This data is mined, sorted, and otherwise utilized to produce salable data provided to data customers 160. Both public and proprietary algorithms can be used to produce data. This data is sold to vendors, broadcasters, manufacturers, wholesalers, monitored websites, and many other customer categories.

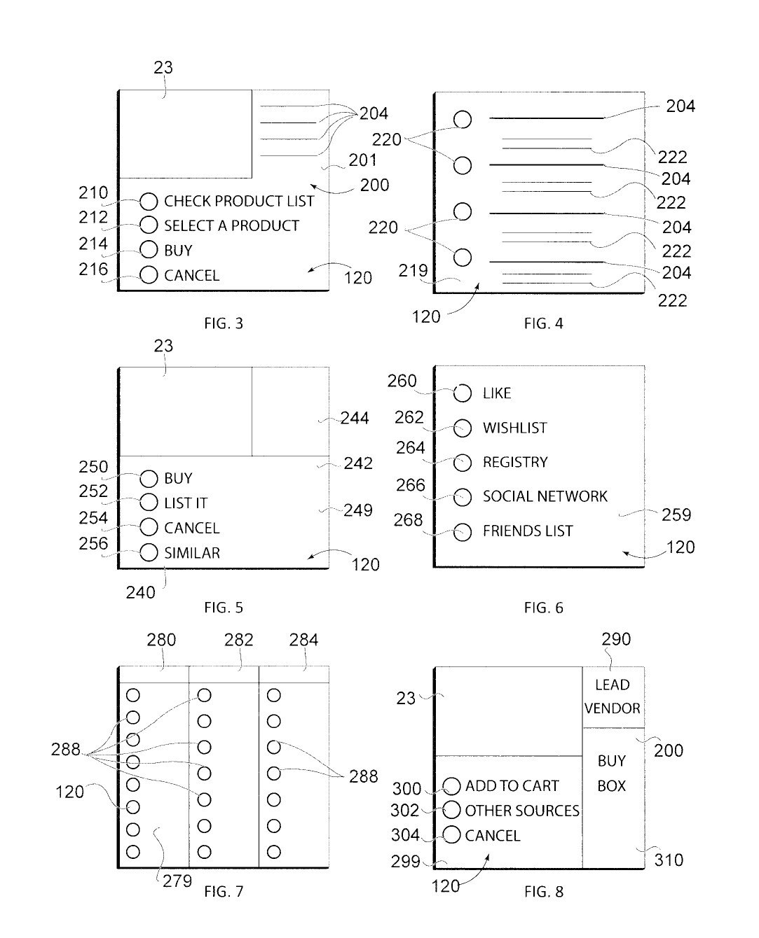

FIG. 3 through FIG. 8 illustrate navigation through successive GUI screens. The path from one GUI screen through one or more other GUI screens is referred to as a decision tree. FIG. 3 is an illustration of a first screen including options to select and access a next graphical user interface screen by operating the user interface device 84 (FIG. 1B). The “list products” command brings up a screen 201 on the GUI 120. In the present illustration, the screen 201 is shown having an L-shape with the picture 23 forming an inset. Other shapes of graphical user interfaces or an overlay, for example, could be provided if desired. In the screen 201 a plurality of product listings 204 may be displayed. A number of options may be provided. Options may be selected from various screen “buttons” that are selectable from the user interface device 84. In the present illustration, the following buttons are provided including 210—check list against a history that has been created; 212—choose a product; 214—buy, and 216—cancel.

Other names can be used for buttons. Larger, smaller, or different sets of buttons could be used on each screen. Other functions consistent with the teachings above could be associated with respective buttons.

In FIG. 4 the list 200 appears on the screen 219. If desired, the list of products 200 may be expanded in size and have a selection button 220 next to each product in response to a product choice command. A brief description 222 may be added below each product listing 204. The user may then select one of the buttons 220, and choose one product to consider.

As seen in FIG. 5, the GUI 120 presents a new screen 249 including product information. In this illustration, the screen 249 has a section 240 for selection buttons, a section 242 for product information, and a section 244 for a product image. The particular juxtaposition of elements displayed in screens of the GUI 120 is not critical, and may be varied.

The screen buttons may include 250—buy, 252—list it, 254—cancel the transaction, and 256—show similar products. Selection of the button 252 leads to the screen 259 in FIG. 6.

The “list it” option, may allow the user 6 the option of listing the product on any of a number of lists. For example, the user 6 may list a particular product on a “likes” list, a wish list, or a gift registry. Button 256 may be provided wherein the user 6 asks the system to provide listings of related products.

In the screen 259 of FIG. 6, the user 6 may select button 260—like, button 262—wish list, button 264—registry. Button 266 may be used to communicate to different social networks. Button 268 may invoke a friends list. For example, a user 6 may include a picture of the product on a bulletin board in Pinterest.

The screen 279 in FIG. 7 may be arranged in any of a number of ways. In the present illustration, columns 280, 282, and 284 are provided to list various categories of similar products. Selection buttons 288 are provided. Selection of a button 288 will lead to a screen, such as the screen 219 in FIG. 4.

Once a user 6 selects the buy button 250 (FIG. 5), the screen 299 of FIG. 8 is displayed. The screen 299 of FIG. 8 lists a vendor and a price. As further described below, the placement of selected vendors and alternative vendors from which the user 6 may choose provides an opportunity for monetization by the promotion company 10. The promotion company 10 may contract with the vendor for a lead position 290 in the shopping display 200. The user 6 may select button 300 for “add to cart.” Button 302 is selected to review other potential sources. The promotion company 10 may contract with an online marketplace such as Amazon.com to be the first alternate choice. Upon selection of the button 302, a “buy box” 310 appears, which lists preferred vendors from the online marketplace. Button 304 is used to cancel and return to a previous screen.

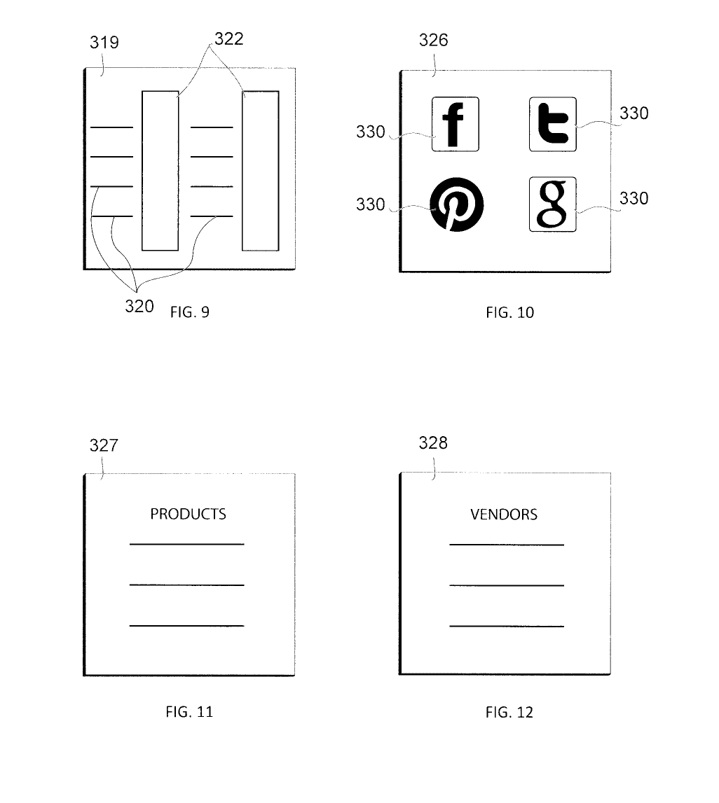

FIG. 9 illustrates a screen 319 produced in response to selection of a “favorite” option such as the registry button 264 in FIG. 6. In one option, the user 6 may populate a list 320 with selected products. Columns 322 may be used as a checklist to denote an action taken with respect to a listed product. For example, where the list 320 is a gift registry, the notation may indicate that another viewer has bought that gift for the user 6. Alternatively, column 322 may be used to denote products bought by a user 6 who is building a collection of items available through the screen 319.

FIG. 10 illustrates a screen 326 used in an alternative embodiment in which the user 6 may report favorite products to a social network as indicated, for example, by icons 330. These social networks could include, for example, Facebook, Twitter, Pinterest, and Google. The user 6 may present lists of interests to friends on a social network by selecting the social network button 266 in FIG. 6.

FIGS. 11 and 12 are illustrations of screens 327 and 328 respectively which are successively produced in response to selection of a “suggest” option. These screens are used to provide a user 6 with alternatives to selected items. The user 6 can then get further information of the merits of items in addition to the item first selected. In the screen 327 of FIG. 11, products may be suggested. In the screen 328 of FIG. 12, vendors may be suggested.

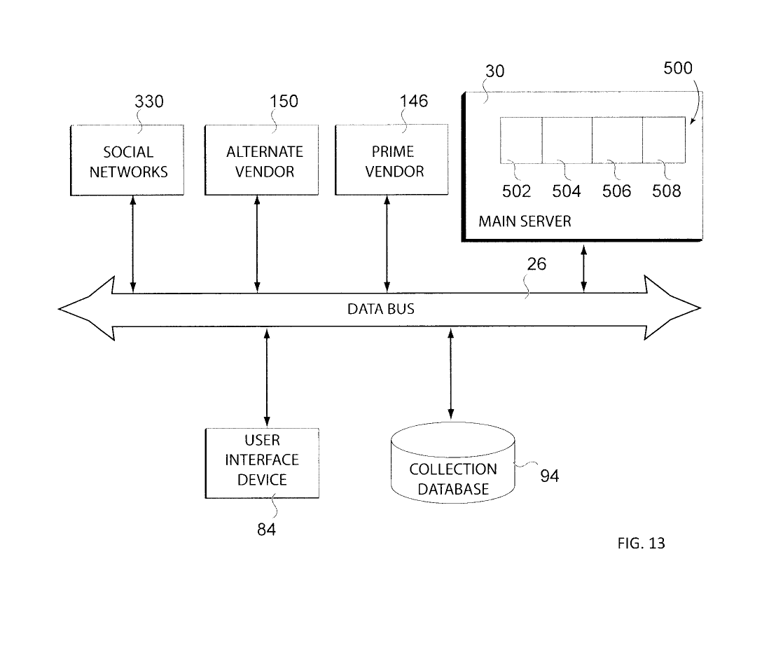

FIG. 13 is an illustration of data gathering in one preferred embodiment. As described above, the components that produce data have communication paths to the main server 30. The main server 30 is programmed to recognize data structures of packets for each form of transmission via the data bus 26. The data is transmitted via packets 500, illustrated as passing through the main server 30.

One way to program the main server 30 is to establish a rule for reading and interpreting preselected packet structures. The main server 30 reads each packet structure and processes segments of each packet 500. In one example, a first packet 500 includes a section 502 identifying the origin of the data. Section 504 includes the destination of the data. Section 506 includes information about the total length of the packet. Section 508 includes the data. Packet structures are each a function of a protocol through which data is transmitted.

The packet 500 may be read to collect monetizeable data. The identity of a particular user 6 may be established by reading section 502. Sections 504 of packets 500 each generated at a different time may be read to establish web sites to which the user 6 connects. The web sites may belong to prime vendors 146, alternate vendors 150, and social networks 330 used by the user 6. The collection database 94 (FIG. 2) may be structured in many different ways in order to collect data for processing.

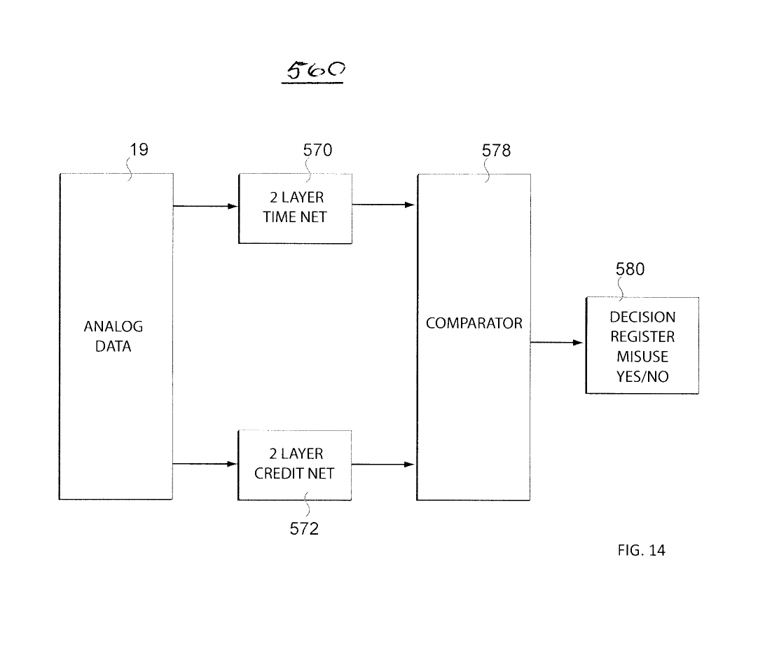

FIG. 14 illustrates an example of a process 560 for conversion of collected data into actionable intelligence. In this particular illustration, the main server 30 detects whether a credit card being used for a purchase is being misused. A number of commercially available programs may be used to perform the algorithms further discussed below. These programs are available under trademarks including C4-5, CART, RIPPER, and BAYES. The server 30 selects data from the collection database 94 (FIG. 13) that represents past credit card use of a user 6. Data is sent for processing in parallel through two different algorithms.

Algorithm 570 is a “two layer time net” algorithm. The algorithm 572 is a “two layer credit net.” The algorithm 570 is based on a typical pattern of sequential behavior of a legitimate user 6. This typical behavior is compared to behavior of a current user. The algorithm 572 is based on the behavior of a thief after copying or stealing a credit card. For example, the thief may use the credit card more often and in more places than a legitimate user 6. Thus sales information is transformed into a value indicative of the mode of use of the credit card.

A comparator 578 compares the results obtained and provides an output to a decision register 580. The comparison determines whether the credit card usage more closely approximates legitimate or criminal use of the credit card. A result is provided to the decision register 580. The decision register 580 can inform the promotion company 10, prime vendor 146 (FIG. 13), or alternate vendor 150. In this manner, a large number of data entries in the collection database 94 are transformed into one actionable piece of data. Patterns, rates, and trends can also be reported. Fraud is only one of many different parameters that may be reported. Metrics can be applied for evaluating sales promotions, for example.

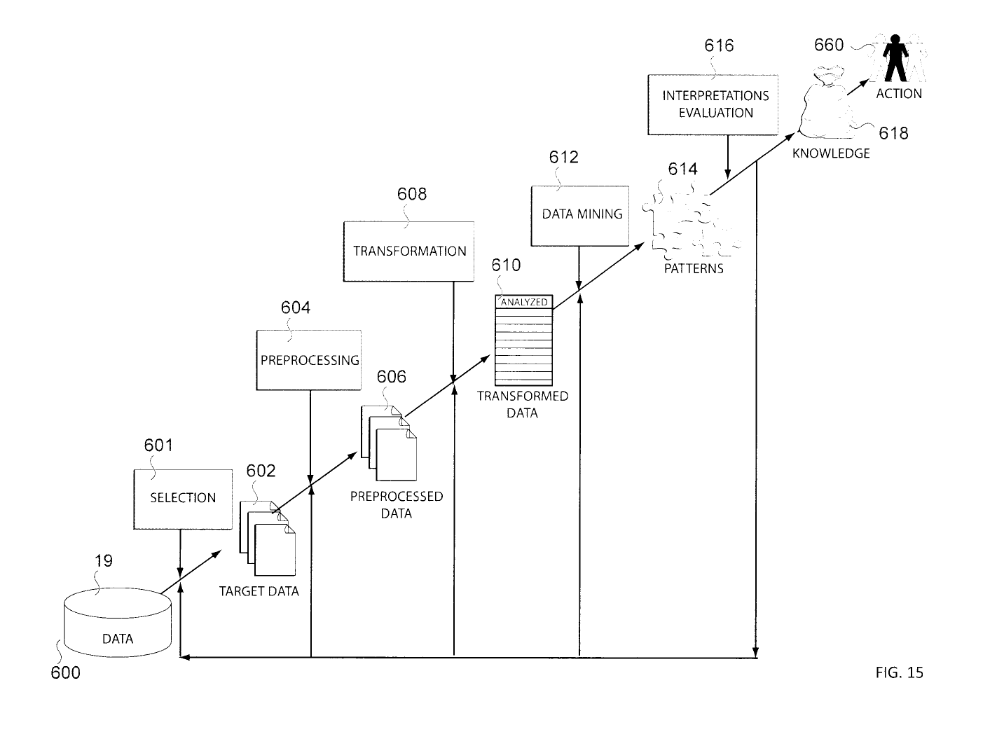

FIG. 15 illustrates a data mining process 600 that may be used with the present method. Applications of data mining can include simulating and optimizing supply chain flows, reducing inventory, and stock-outs by prime and alternative vendors. It can also include identifying customers with the greatest profit potential, identifying the price that will maximize yield or profit, return on investment for each advertising campaign, detecting and minimizing fulfillment problems on the part of vendors, and providing a better understanding of the drivers of financial performance including non-economic factors.

Each selection step described here also comprises a subroutine in a program and is performed in a part of the program processor 36 (FIG. 1A). In a selection step 601, target data 602 gets selected from the collection database 94 (FIG. 1B) or is created from information in the collection database 94. Only relevant information is selected, and also metadata or data that represents background knowledge. At step 604, preprocessed data 606 is produced. Elements of the preprocessing step 604 may include the cleaning of wrong data, the treatment of missing values, and the creation of new attributes. In transformation step 608, the preprocessed data is converted to provide transformed data 610. The transformed data 610 also is manually or automatically reduced.

In a data mining phase 612, the data mining task is performed. Various public and proprietary data mining algorithms are available to produce information from collected data. In a nominal application, the output of the data mining step 612 is data in the form of detected patterns 614. At interpretive evaluation step 616, interpretation of the detected patterns reveals whether the detected patterns contain knowledge 618. Knowledge 618 may be separated into categories of interest to different market segments and selectively provided to data customers 160.

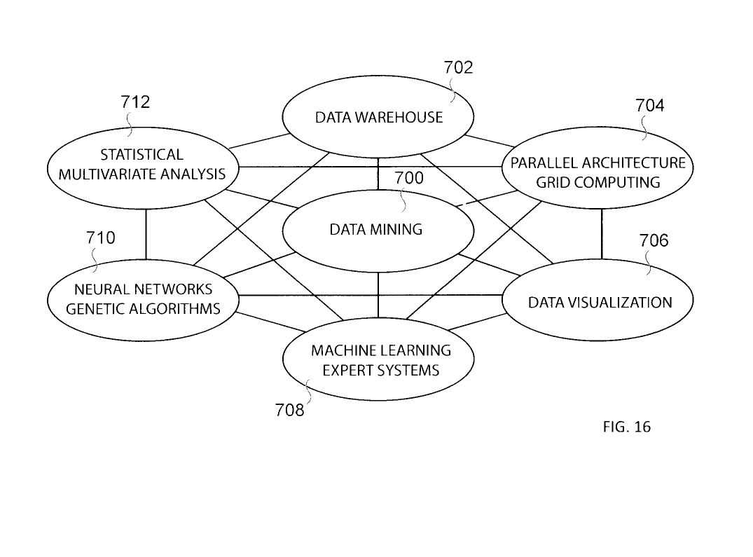

FIG. 16 illustrates various data-handling algorithms that may interact in the use of the present method. A data mining routine 700 will utilize a data warehouse 702. Depending on the data to be produced, the routine 700 may use parallel architecture grid computing 704, data visualization 706, machine learning expert systems 708, neural networks and genetic algorithms 710, and statistical multivariate analysis 712. These various methods can be used alone or can be programmed to interact with others of these methods.

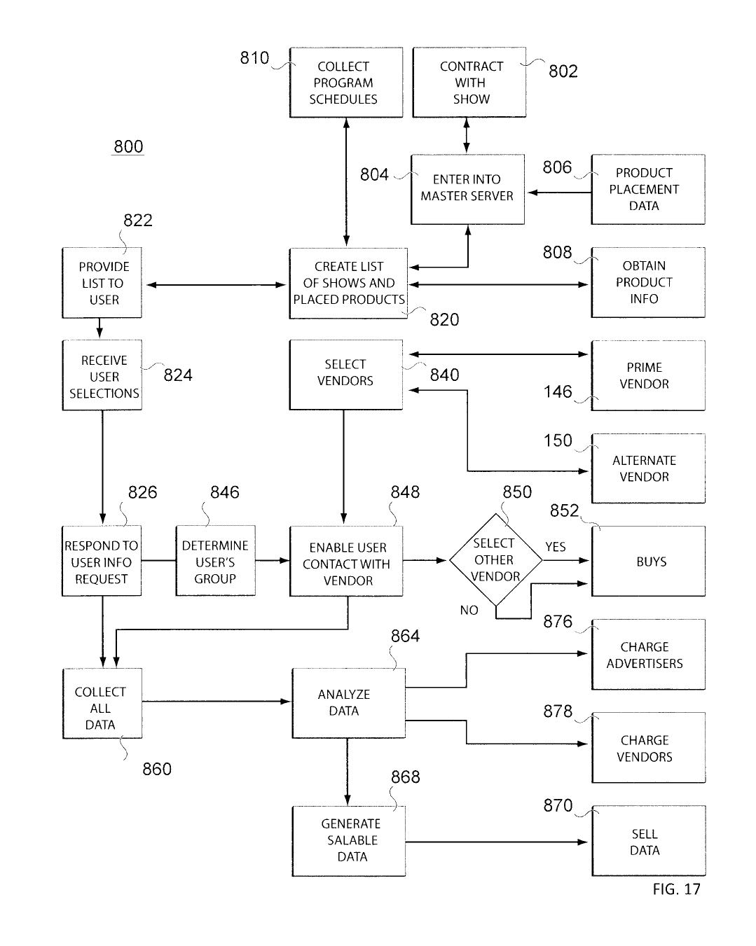

FIG. 17 is a flowchart illustrating a method and non-transitory machine-readable medium 800 for monetizing transactional information of the promotion company 10 and the user 6 in accordance with the present subject matter. Unless it would lead to a logical contradiction, the steps depicted need not occur in the order illustrated.

At step 802, the promotion company 10 contracts with a program company 14 to establish a relationship in which the promotion company 10 will provide an enhanced audience for viewing product placements. Step 804 enters data into the master server 30. Product placement data is provided at step 806 and stored by another performance of step 804. Product information is obtained at step 808 in any of a number of ways, such as search by the promotion company 10, provision by the program company 14, provision by vendors, or otherwise. At step 804 data is written to the master server 30. At step 810, program schedules are collected and then written into the master server 30 by performing step 804.

A step 820 queries the master server 30 and creates a list of contracted shows, schedules, and placed products. At step 822 the list is provided for availability via the communications link 20 (FIG. 1A). A step 824 is invoked in response to user operation of the user interface device 84 (FIG. 1B). User selections are read and decoded. At step 826 information is provided in response to the user request. The information may be product information or other information that can be accessed by use of the user interface device 84 (FIG. 1B) as described above.

In advance of this step, the promotion company 10 concludes its arrangements with the prime vendors 146 and alternate vendors 150. In step 846, the group in which the user 6 is included is determined by comparison to a list of groups. Then a prime vendor 146 is selected corresponding to the group of the particular user 6. The user 6 is provided with a link to a preferred vendor corresponding to the user 6's group at step 848. At step 850 the user 6 decides whether to connect to the prime vendor or to an alternate vendor. At step 852 the user 6 buys from a vendor which the user 6 has decided to use.

At step 860 data is collected in the collection database 94. At step 864 data selection and data mining are performed by the data analyzer 102 (FIG. 1B). Salable data defined by preselected parameters is generated at step 868 and sold to data customers 160 at step 870. At step 876 charges to advertisers are calculated. This may be based on a flat rate, number of clicks, or days of display. At block 878 charges to each vendor are calculated. The charges may be based on number of clicks, gross dollar sales, or any number of parameters used in e-commerce to determine a commission for a referring site.

While the foregoing written description of the subject matter enables one of ordinary skill to make and use what is considered presently to be the best mode thereof, those of ordinary skill will understand and appreciate the existence of variations, combinations, and equivalents of the specific embodiment, method, and examples herein. The subject matter should therefore not be limited by the above described embodiment, method, and examples, but by all embodiments and methods within the scope and spirit of the subject matter.

TABLE I
App Description Table

| No. | Section/Feature/Function | Remarks |
|---|---|---|
| 1.0 | Splash Screen | App Branding |
| | | Logo |
| | | Name |
| | | Tagline |
| 2.0 | Sign-In | Facebook Sign-Up/Sign-In |
| 3.0 | Home Stream | App opens to this section |
| | | Aggregated Chronological Stream to include |
| | | following Content/Posts: |
| | | Newly Added Products |
| | | Staff Picks |
| | | Featured/Sponsored Products |
| | | Upcoming Show Reminders [subject to |
| | | appropriate content availability] |
| | | Central Drop-down Filter/Shortcut Tab, to include: |
| | | Sponsored [by Filter] |
| | | Staff Picks [by Filter] |
| | | Shows [by Shortcuts to each Branded Show |
| | | Stream] |
| | | Side Menu/App Hub [see section 7.0] |
| 4.0 | Show Stream | Show Cover Photo [from latest season's marketing |
| | | collaterals] |
| | | Chronological Stream of Show Related Product Posts |
| 5.0 | Product Detail Page | Photo |
| | | Product Name |
| | | Product Description |
| | | “Favoriting” [i.e. Tagging]/Add to WishList [default |
| | | auto sharing to Facebook] |
| | | “Unfavoriting”/Remove from WishList |
| | | Buy default auto sharing to Facebook, subject to |
| | | commercial business model] |
| | | Share, to a minimum of the below: |
| | | Facebook |
| | | Twitter |
| | | Email |
| | | User Comments [one level] |
| | | User Thumbnail/Name links to User's |
| | | Profile/Stream |
| | | Comment Text Box and Send Button |
| | | Show Name [link to relevant Show Stream] |
| | | Back Button |
| 6.0 | User Profile/Stream | User's Thumbnail Photo [from Facebook] |
| | | User's Name |
| | | User's App Tagline [e.g. “I'm a Shoe-a-holic”] |
| | | Tab for WishList and BoughtList |
| | | Chronological List of Posts of User's WishList |
| | | Chronological List of Posts of User's BoughtList |
| | | Back Button |
| 7.0 | Side Menu/App Hub | List of app shortcuts with icons to include, and accessible via |
| | | side menu button on most pages: |
| | | Home Stream |
| | | My Profile |
| | | Friends List [i.e. Facebook Friends who have this |
| | | app] |
| | | Shows List |
| | | Invite/Share App |
| | | Account/Orders [subject to commercial business |
| | | model decisions] |
| | | Settings [if required] |
| | | App Support [by way of Native Email] |
| | | Contact Us/Suggest a Show/Product & Vendor |
| | | Enquiries [by way of Native Email] |
| | | About |
| | | Sign Out |
| 8.0 | My Profile | As per User Profile Stream in point 6.0 above, with: |
| | | Editable Profile Photo |
| | | From OS Native Camera |
| | | From Existing OS Native Photo Albums |
| | | Editable Profile App Tagline |
| | | “Unfavoriting”/Remove Product(s) from WishList |
| 9.0 | Friend List | Auto populating, scrollable alphabetical list of User's |
| | | Facebook Friends who use this app |
| | | Friend Thumbnail Photo |
| | | Friend Name |
| | | Friend's App Tagline |
| | | Pull to Refresh List [keeps alphabetical |
| | | integrity of list] |
| 9.0 | Show List | Scrollable Grid or Stream of TV Shows: |
| | | TV Show Photo |
| | | TV Show Name |
| | | TV Show Marketing Line |
| | | Tapping on TV Show takes user to TV Show |
| | | Stream |
| 10.0 | Account & Order | Dependent on Commercial/Business Model final |
| | | decisions |
| 11.0 | About | App Version No/Info |
| | | Developer Name/Email |
| | | Privacy Policy [via weblink] |
| | | Terms of Use/Service [via weblink] |
| | | Unique User ID [if appropriate] |
| | | IP & Copyright Information Statement |

Notes & Assumptions
All screens will be designed and rendered on the target devices in portrait mode.
The table above represents the appropriate feature set in accordance with the proposed number of TV Shows and Product Database at launch
A simple/manual version 1-appropriate mechanism for inappropriate Profiles and Posts may be provided
All Stream screens will have a Pull-to-Refresh Feature where appropriate

Web based CMS Description Table

| No. | Section/Feature/Function | Remarks |
|---|---|---|
| 1.0 | Sign In Page | Allows user to enter username and password to enter |
| | | the CMS system |
| | | 3 accounts will be provided to access the CMS - all |
| | | will have the same level of access |
| | | Requests for change of password or users is by email |
| | | to, e.g., promotion company |
| 2.0 | Product List Page (Home) | Displays a table of all products chronologically listed |
| | | Product Name |
| | | Promotion Company Product Number |
| | | Vendor Name |
| | | Vendor Product Number |
| | | Selling Price |
| | | Product Photo/Thumbnail |
| | | Show Name |
| | | Date Added/Updated |
| | | Staff Pick and/or Featured Product Indicator |
| | | Edit and Delete buttons will be available next to each |
| | | product listed in the table above; Delete would ask |
| | | for a confirmation box before deleting and edit would |
| | | take the user to the Edit Product Page |
| | | Show List Button that would navigate the user to the |
| | | ‘Show List Page’ |
| | | Add New Button that would take the user to ‘Add |
| | | New Product Page” |
| 3.0 | Show List Page | Displays a table of all the shows sorted based on |
| | | assigned show priority |
| | | Show Priority in terms of order shown on |
| | | Show Grid in app |
| | | Show Name |
| | | Show Thumbnail |
| | | Show Marketing Line [if appropriate, and |
| | | maybe character max applied here] |
| | | Edit and Delete buttons will be available next to |
| | | each show listed in the table above; Delete would |
| | | ask for a confirmation box before deleting and edit |
| | | would take the user to the ‘Edit Show Detail Page’ |
| | | Button that would navigate the user to the Product List |
| | | page |
| 4.0 | Edit Product Detail Page | Input fields with product information populated |
| | | Photo [Photo visible with edit button to |
| | | change it] - Upload photo from local drive |
| | | with correct suggested photo dimensions |
| | | Product Name - Single line Text box |
| | | Product Description - Multi-line Text area |
| | | Selling Price |
| | | Shipping Info [subject to commercial and |
| | | business model] |
| | | Vendor Name |
| | | Vendor Product Number |
| | | Buy Link [subject to change based on |
| | | business/commercial decision] - Text box |
| | | Show Name - Dropdown with selection of |
| | | available shows |
| | | Staff Pick - Checkbox to mark the product as a |
| | | staff pick |
| | | Featured Product - Checkbox to mark the |
| | | product as a featured pick |
| 5.0 | Add New Product Page | Input fields for entering new product information |
| | | Photo - Upload photo from local drive with |
| | | correct suggested photo dimensions |
| | | Product Name - Single line Text box |
| | | Product Description - Multi-line Text area |
| | | Selling Price |
| | | Shipping Info [subject to commercial and |
| | | business model] |
| | | Vendor Name |
| | | Vendor Product Number |
| | | Buy Link [subject to change based on |
| | | business/commercial decision] - Text box |
| | | Show Name - Single-Select Dropdown with |
| | | selection of available shows |
| | | Staff Pick - Checkbox to mark the product as a |
| | | staff pick |
| | | Featured Product - Checkbox to mark the |
| | | product as a featured pick |
| 6.0 | Edit Show Detail Page | Input fields with show information populated |
| | | Show Priority - Single line Textbox that allows |
| | | unique numbers between 1-10 |
| | | Show Name - Single Line Textbox |
| | | Show Description - Multiline Text Area |
| | | Show Marketing Image (Size 1) - Upload |
| | | photo from local drive with correct |
| | | suggested photo dimensions |
| | | Show Marketing Image (Size 2) - Upload |
| | | photo from local drive with correct suggested |
| | | photo dimensions |
| | | Show Marketing Line [if appropriate, and |
| | | maybe character max applied here] |
| 7.0 | Add New Show Page | Input fields for entering new show information |
| | | Show Priority - Single line Textbox that allows |
| | | unique numbers between 1-10 |
| | | Show Name - Single Line Textbox |
| | | Show Description - Multiline Text Area |
| | | Show Marketing Image (Size 1) - Upload |
| | | photo from local drive with correct |
| | | suggested photo dimensions |
| | | Show Marketing Image (Size 2) - Upload |
| | | photo from local drive with correct suggested |
| | | photo dimensions |
| | | Show Marketing Line [if appropriate, and |
| | | maybe character max applied here] |

Notes & Assumptions:
Main Assumption: the above CMS table is dependent on final commercial & business model decisions
For Reporting Purposes Google Analytics Integration may be used in the alternative to more rigorous programs.

1. A method for making product placement data monetizeable comprising:
obtaining a product placement list for a preselected program;
assembling product data for products which are the subject of product placement data;
assembling vendor data to be associated with each product;
storing said product data and said vendor data in storage;
producing a data block comprising data for transmission to a user, the data block comprising data for providing selected decision trees to a user;
providing said data block to a program company for inclusion in a media package for transmission via a channel, the channel providing data to a user;
receiving signals from a user indicative of user selections;
accessing stored data in correspondence with user selections to obtain accessed data;
providing to the user the accessed data and providing options to select a data transaction;
collecting data indicative of actions of a plurality of users; and
reducing the data to generate consumer data.

2. A method according to claim 1 wherein the data block transmitted to a user comprises a definition of a graphical user interface for superimposition on a program viewing screen.

3. A method according to claim 2 wherein product data comprises fields each containing product descriptions.

4. A method according to claim 3 wherein vendor data comprises data regarding a plurality of vendors, the plurality of vendors including a preferred vendor associated with each product.

5. A method according to claim 4 further comprising registering of a selection of a vendor by a user.

6. A method according to claim 5 further comprising registering of a sale by a selected vendor to a user.

7. A method according to claim 1 wherein providing data to and receiving data from users comprises connection via social media.

8. A method according to claim 1 wherein a plurality of graphical user interfaces provide a decision tree including at least one branch leading to a next decision tree.

9. A method according to claim 1 for registering selections by a plurality of users and performing rule-based data reduction.

10. A method according to claim 1 further comprising providing an app to an entity providing user interface devices for interaction, the app providing functionality to interface with the steps of the method.

11. A method for generating monetizeable data based on product placements in programs comprising:
selecting user data parameters from which monetizeable data can be generated;
providing to users a product placement list for a preselected program;
providing to the users via a data channel a data block comprising information corresponding to a current preselected program being viewed by a user;
providing product data in the data block for placed products and selection options for making user selections corresponding to user data parameters;
storing product data and selecting and storing vendor data associated with a respective product in a data memory;
receiving signals from a user indicative of user selections;
accessing data from the memory in correspondence with user selections in order to obtain accessed data;
providing to the user the accessed data;
collecting data from a plurality of users indicative of the selected user data parameters; and
analyzing data indicative of the selected user data parameters according to preselected rules.

12. A method according to claim 11 wherein analyzing data indicative of the selected user data parameters comprises generating reports of consumer data for delivery in a preselected manner.

13. A method according to claim 11 further comprising generating monetizeable data by utilizing an algorithm to produce a decision based on actionable intelligence embodied in user data.

14. A method according to claim 11 wherein choices available to a user at one decision branch comprise a first menu of data transactions and wherein the method further comprises providing a next level of available data transactions.

15. A method according to claim 11 further comprising providing a user an option to make selections on a social media menu and including social media selections as user data parameters.

16. A non-transitory machine-readable medium that provides instructions, which when executed by a processor, causes said processor to perform operations for generating monetizeable data based on product placements in programs comprising:
selecting user data parameters from which monetizeable data can be generated;
providing to users a product placement list for a preselected program;
providing to the users via a data channel a data block comprising information corresponding to a current preselected program being viewed by a user;
providing product data in the data block for placed products and selection options for making user selections corresponding to user data parameters;
storing product data and selecting and storing vendor data in a data memory associated with a respective product;
receiving signals from a user indicative of user selections;
accessing data from the memory in correspondence with user selections in order to obtain accessed data;
providing to the user the accessed data;
collecting data from a plurality of the users indicative of the selected user data parameters; and
analyzing data indicative of the selected user data parameters according to preselected rules.

17. A non-transitory machine-readable medium according to claim 16 wherein product data comprises fields each containing product descriptions.

18. A non-transitory machine-readable medium according to claim 17 wherein user data parameters comprise social media interactions and further comprising providing a user the option to make selections on a social media menu.

19. A method according to claim 16 wherein analyzing data indicative of the selected user data parameters comprises generating reports of consumer data for delivery in a preselected manner.

20. A method according to claim 16 further comprising generating monetizeable data by utilizing an algorithm to produce a decision based on actionable intelligence embodied in user data.
